(19) United States
(12) Patent Application Publication
(10) Pub. No.: US 2026/0065371 A1
(43) Pub. Date: Mar. 5, 2026

(54) INTELLIGENT PLATFORM FOR RECOMMENDING FINANCIAL ADVICE TO A USER AND A METHOD FOR RECOMMENDING THEREOF

(71) Applicant: SUMMA TECHNOLOGIES LTD, Jerusalem (IL)

(72) Inventors: ROI KATZ, Jerusalem (IL); DAN SAAR, Holon (IL)

(73) Assignee: SUMMA TECHNOLOGIES LTD, Jerusalem (IL)

(21) Appl. No.: 18/817,234

(22) Filed: Aug. 28, 2024

(51) Int. Cl. G06Q 40/06

(52) U.S. Cl. CPC G06Q 40/06

(57) ABSTRACT

There is disclosed an intelligent platform for recommending financial advice to a user. The intelligent platform (100) comprises a data collection module (102) configured to gather real-time data from various financial streams, while a database arrangement (104) stores audit standards and other professional guidelines associated with these streams. A processing arrangement (106) characterizes audit standards into a unified unit and connects financial streams accordingly. An AI module (108) analyzes data using this unified unit, creating personalized queries for gathering user-specific information and generating personalized insights. The AI module (108) leverages real-time data and user input to provide insights into financial and audit processes. A document generator (110) creates reports based on data analysis, and a display arrangement (112) presents these reports to users, offering tailored financial recommendations. Furthermore, the present disclosure also discloses a method (200) for recommending financial advice to a user.

### FIELD OF INVENTION

In general, the present invention relates to an intelligent platform and a method for recommending financial advice to a user. In particular, the present disclosure relates to an intelligent platform for recommending financial advice to a user, using a custom data collection process and analysing the collected data via an AI module. Furthermore, the present disclosure also relates to a method for recommending financial advice to a user using a custom data collection process.

### BACKGROUND

In the current landscape of financial advisory services, various technologies facilitate the provision of financial advice to users. Financial institutions and independent advisory platforms utilize software systems that integrate with banking services, investment accounts, and credit monitoring tools to gather comprehensive financial data about users. Such systems employ algorithms to assess risk tolerance, predict future financial scenarios, and suggest optimal investment strategies. Moreover, there are platforms that provide automated financial planning through robo-advisors, which offer low-cost, scalable solutions for managing personal finances.

The Financial Services industry today is technologically advanced—for example, there are applications of investment recommendations, credit monitoring tools gather comprehensive financial data about users, systems employ algorithms to assess risk tolerance, predict future financial scenarios, and suggest optimal investment strategies. There are platforms that provide automated financial planning and so forth.

On the other hand, the world of accounting, auditing and financial management lags behind. Auditors, accountants and financial managers routinely perform many repetitive actions, there is a disconnection between different systems they use and they need to copy data from one system to the other, the data is not automatically updated on a real-time basis and retrospective documentation of actions performed is needed.

These create inefficiency, bureaucracy, employee dissatisfaction, as well as challenges the audit quality and compliance with audit standards/financial management quality and compliance with regulatory requirements.

Therefore, in light of the foregoing discussion, there exists a need to overcome the aforementioned drawbacks so as to provide a platform and a method for providing financial advice to a user.

The present invention is designed to solve these problems and meet the need of the field of accounting, auditing and financial management to advance and become technological and efficient.

### SUMMARY

In general, the present invention relates to an intelligent platform and a method for recommending financial advice to a user. In particular, the present disclosure relates to an intelligent platform for recommending financial advice to a user, using a custom data collection process and analysing the collected data via an AI module. Furthermore, the present disclosure also relates to a method for recommending financial advice to a user using a custom data collection process.

One aspect of the present disclosure provides an intelligent platform for recommending financial advice using a custom data collection process, to a user, wherein the intelligent platform comprising: a data collection module configured to collect real-time data associated with a plurality of financial streams; a database arrangement operatively coupled to the data collection module, the database arrangement comprises a plurality of audit standards or other professional standards for financial processes, associated with the plurality of financial streams; a processing arrangement communicably coupled to the database arrangement via a data communication network, the processing arrangement is configured to: receive the real-time data from the plurality of financial streams; characterize the plurality of audit standards associated with the plurality of financial stream, into a unified audit and compliance unit; and integrate and connect the each of the plurality of financial streams with the unified audit and compliance unit; an Artificial Intelligence, AI module for analysing all or part of the real-time data from the plurality of financial streams using the unified audit and compliance unit and thereby creating a personalized query based process for gathering and validating specific personalized information from the user, for determining personalized insights associated thereof, wherein the AI module analyses the real-time data from at least one of the plurality of financial streams in the unified audit and compliance unit, and the specific personalized information from the user, to provide insights of at least one of a financial or audit processes; a document generator for generating at least one report associated with the at least one financial or audit process based on the analysis of the real-time data; and a display arrangement communicably coupled to the document generator, for displaying the generated at least one report, and recommending advice to the user.

Another aspect of the present disclosure provides that the intelligent platform further comprises a user interface for receiving a user input in form of at least one query thereof via at least one user, and wherein the at least one query is associated with querying the data relevant to at least one of the plurality of financial stream.

Another aspect of the present disclosure provides that the user interface displays data associated with the at least one of the plurality of financial streams, to the display arrangement, based on the at least one query.

A further aspect of the present disclosure provides that the plurality of financial streams refer to the data associated with multiple aspects of the plurality of financial processes, and wherein the multiple aspects of the plurality of financial processes comprises at least one of bookkeeping, audit, tax, financial management.

Still further aspect of the present disclosure provides that the AI module is trained using the data from the plurality of financial streams, and thereby optimizes each or at least a part of the plurality of financial processes.

Yet further aspect of the present disclosure provides that the intelligent platform is configured to operate in a cloud-based architecture for providing seamless access and real-time updates.

Another aspect of the present disclosure provides that the AI module is configured to automate the at least one of the financial processes.

Still another aspect of the present disclosure provides that the display arrangement displays data associated with the analysed insightful insights, and wherein the displayed data corresponds to insightful data in form of the generated report, and relevant data analytics.

Yet another aspect of the present disclosure provides that the intelligent platform further comprises an API integration module for providing integration thereof with existing systems.

A further aspect of the present disclosure provides that the intelligent platform further comprises an Optical character recognition, OCR module for automating extraction of data, minimizing reliance on manual input, and ensuring an error-free process.

Another aspect of the present invention provides that the intelligent platform of Claim 1, wherein each of the plurality of audit standards comprises: roles and responsibilities; risk assessment and response to assessed risks; audit evidence; using data from external sources; and audit conclusion and reporting.

Yet another aspect of the present invention provides that method for recommending financial advice to a user using a custom data collection process, the method comprises: collecting real-time data associated with a plurality of financial streams using a data collection module; accessing a database arrangement operatively coupled to the data collection module, wherein the database arrangement comprises a plurality of audit and other professional standards linked with the plurality of financial streams; receiving the real-time data from the plurality of financial streams via a processing arrangement communicably coupled to the database arrangement through a data communication network; characterizing the plurality of audit and other professional standards associated with the plurality of financial streams into a unified audit and compliance unit; integrating and connecting each of the plurality of financial streams with the unified audit and compliance unit; utilizing an Artificial Intelligence (AI) module to analyze the real-time data from the plurality of financial streams using the unified audit and compliance unit and thereby creating a personalized query based process for gathering and validating specific customised information from the user, for determining customised insights associated thereof; analysing via the AI module, the real-time data from at least one of the plurality of financial streams in the unified audit and compliance unit, and the specific customised information from the user, to provide insights of at least one financial or audit processes, thereby supporting and documenting thereof; generating at least one report associated with the at least one financial or audit process using a document generator; and displaying the generated at least one report using a display arrangement communicably coupled to the document generator, and thereby recommend an advice thereof.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

A better understanding of the present invention may be obtained through the following examples which are set forth to illustrate but are not to be construed as limiting the present invention.

### BRIEF DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a schematic illustration of a block diagram of an intelligent platform (100) for recommending financial advice using a custom data collection process, in accordance with an embodiment of the present disclosure;

FIG. 1B is a schematic illustration of a block diagram of an intelligent platform (100b) for recommending financial advice using a custom data collection process, in accordance with another embodiment of the present disclosure;

FIG. 1C is a schematic illustration of a block diagram of an intelligent platform (100c) for recommending financial advice using a custom data collection process, in accordance with another embodiment of the present disclosure;

FIGS. 2A and 2B are a schematic illustration of a flow diagram of a method (200) for recommending financial advice to a user using a custom data collection process, in accordance with an embodiment of the present disclosure;

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item to which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognise that other embodiments for carrying out or practising the present disclosure are also possible.

In a first aspect, embodiments of the present disclosure provide An intelligent platform (100) for recommending financial advice using a custom data collection process, to a user, wherein the intelligent platform (100) comprising:
a data collection module (102) configured to collect real-time data associated with a plurality of financial streams;
a database arrangement (104) operatively coupled to the data collection module (102), the database arrangement (104) comprises a plurality of audit standards or other professional standards, such as but not limited to tax laws for financial processes, associated with the plurality of financial streams;
a processing arrangement (106) communicably coupled to the database arrangement (104) via a data communication network, the processing arrangement (106) is configured to:
   receive the real-time data from the plurality of financial streams;
   characterize the plurality of audit standards and other professional standards associated with the plurality of financial stream, into a unified audit and compliance unit; and
   integrate and connect the each of the plurality of financial streams with the unified audit and compliance unit;
an Artificial Intelligence, AI module (108) for analysing the real-time data from the plurality of financial streams using the unified audit and compliance unit and thereby creating a personalized query based process for gathering and validating specific customised information from the user, for determining customised insights associated thereof,
wherein the AI module (108) analyses the real-time data from at least one of the plurality of financial streams in the unified audit and compliance unit, and the specific customised information from the user, to provide insights of at least one of a financial or audit processes;
a document generator (110) for generating at least one report associated with the at least one financial or audit process based on the analysis of the real-time data; and
a display arrangement (112) communicably coupled to the document generator (110), for displaying the generated at least one report, and recommending advice to the user.

In a second aspect, embodiments of the present disclosure provide a method (200) for recommending financial advice to a user using a custom data collection process, the method comprises:
collecting real-time data associated with a plurality of financial streams using a data collection module (202);
accessing a database arrangement operatively coupled to the data collection module, wherein the database arrangement comprises a plurality of audit and other professional standards linked with the plurality of financial streams (204);
receiving the real-time data from the plurality of financial streams via a processing arrangement communicably coupled to the database arrangement through a data communication network (206);
characterizing the plurality of audit and other professional standards associated with the plurality of financial streams into a unified audit and compliance unit (208);
integrating and connecting each of the plurality of financial streams with the unified audit and compliance unit (210);
utilizing an Artificial Intelligence (AI) module to analyze the real-time data from the plurality of financial streams using the unified audit and compliance unit and thereby creating a customised query based process for gathering and validating specific customised information from the user, for determining customised insights associated thereof (212);
analysing via the AI module, the real-time data from at least one of the plurality of financial streams in the unified audit and compliance unit, and the specific personalized information from the user, to provide insights of at least one financial or audit processes, thereby supporting and documenting thereof (214);
generating at least one report associated with the at least one financial or audit process using a document generator (216); and
displaying the generated at least one report using a display arrangement communicably coupled to the document generator, and thereby recommend an advice thereof (218).

The present invention discloses an intelligent platform (100) that reads and uses real-time data to integrate bookkeeping, audits, tax, and financial management, and so forth into one streamlined application for audit and compliance. Said innovative platform offers a comprehensive solution by “opening” and reading compositions originated by any bookkeeping system. By doing so, it directly and easily uses the data to generate reports and queries. Additionally, the disclosed intelligent platform automatically performs various stages of the audit work, prepares financial statements, and includes a document generator along with audit quality control tools.

Furthermore, the intelligent platform also employs advanced technologies such as artificial intelligence (AI) and machine learning to optimize various financial processes, ranging from audits to tax report transmission, and thereby enabling the intelligent platform to provide efficient and accurate financial data processing, ensuring high-quality outcomes for users. Consequently, by leveraging AI and machine learning, the present invention enhances the analysis and interpretation of financial data, improving the accuracy and efficiency of financial processes such as audits and tax reporting.

It will be appreciated that the disclosed platform is built with scalability, security, that utilize cloud computing, artificial intelligence, and machine learning models, Moreover, the disclosed platform also ensures real-time, accurate financial data processing and insightful analytics. In addition, the intelligent platform disclosed by the intelligent platform provides deep insights and comprehensive reporting based on real-time financial data. Such analytics enable users to gain a holistic view of the financial situation. Also, API integrations facilitate seamless connectivity with various financial systems and services, ensuring that users can easily access and manage financial information across different platforms.

In an embodiment, the disclosed platform also incorporates OCR (Optical Character Recognition) technology, which allows for the efficient digitization and processing of paper-based financial documents. Such feature enhances the system's ability to handle diverse types of financial data, ensuring that all relevant information is accurately captured and processed.

Throughout the present disclosure, the term “database arrangement” as used herein, relates to an organized body of digital information regardless of the manner in which the data or the organized body thereof is represented. It refers to a collection of data that allows easy access, management, and updating of the data stored. Optionally, the database arrangement may be hardware, software, firmware, and/or any combination thereof. For example, the organized body of digital information may be in a form of a table, a map, a grid, a packet, a datagram, a file, a document, a list or in any other form. Optionally, the data in the database arrangement is organized into rows, columns, and tables. Additionally, optionally, the data in the database arrangement is indexed (namely, labelled) for easy access thereto. Optionally, the database arrangement comprises a set of processes (namely instructions) to create the plurality of databases and update thereto, query data from external sources, and process operational instructions provided thereto. Optionally, the database arrangement is accessed electronically for, for example storing data, accessing data, and updating data, using a computing device. More optionally, such a computing device employs a database management system (DBMS) for creating and managing the database arrangement. Furthermore, optionally, the database arrangement is an object-oriented database, SQL database, relational database, distributed database, non-SQL database, cloud database. The plurality of databases includes any data storage software and systems, such as, for example, a relational database like IBM DB2®, Google Cloud and Oracle 9®. Furthermore, the database arrangement also includes a software program for creating and managing one or more databases. Optionally, the database arrangement may be operable to support relational operations, regardless of whether it enforces strict adherence to a relational model, as understood by those of ordinary skill in the art. Additionally, the database arrangement is populated by the elastic search libraries, elastic search databases, at least one relevant data element, topic-based web content and the likes. Optionally, the database arrangement is populated by the operational data associated with the URIs, URLs, and/or URNs and their related information.

Throughout the present disclosure, the term “processing arrangement” as used herein relates to at least one programmable or computational entity configured to acquire process and/or respond to instructions identifying related proteins. For example, the computational entity may include a memory, a network adapter and the likes. In another example, the processor includes, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit for executing data management and curation instructions. Furthermore, the processor includes one or more processing devices and various elements of a computer system associated with a processing device that may be shared by other processing devices. Additionally in an embodiment, one or more processors, processing devices, processing devices, and elements are arranged in various architectures for responding to and processing the instructions that drive the system for determining related proteins.

Throughout the present disclosure, the term “data communication network” refers to individual networks or a collection thereof interconnected with each other and functioning as a single large network. Optionally, such a data communication network is implemented by way of a wired communication network, wireless communication network, or a combination thereof. It will be appreciated that a physical connection is established for implementing the wired communication network, whereas the wireless communication network is implemented using electromagnetic waves. Examples of such data communication networks include, but are not limited to, Local Area Networks (LANs), Wide Area Networks (WANs), Metropolitan Area Networks (MANs), Wireless LANs (WLANs), Wireless WANS (WWANs), Wireless MANS (WMANs), the Internet, second-generation (2G) telecommunication networks, third generation (3G) telecommunication networks, fourth-generation(4G) telecommunication networks, fifth-generation (SG) telecommunication networks and Worldwide Interoperability for Microwave Access (WiMAX) networks.

Optionally, the data communication network is implemented as a cellular network. It will be appreciated that the cellular network refers to a radio communication network, wherein the cellular network is distributed over land through cells. Specifically, each cell includes a fixed location transceiver, for example, a base station.

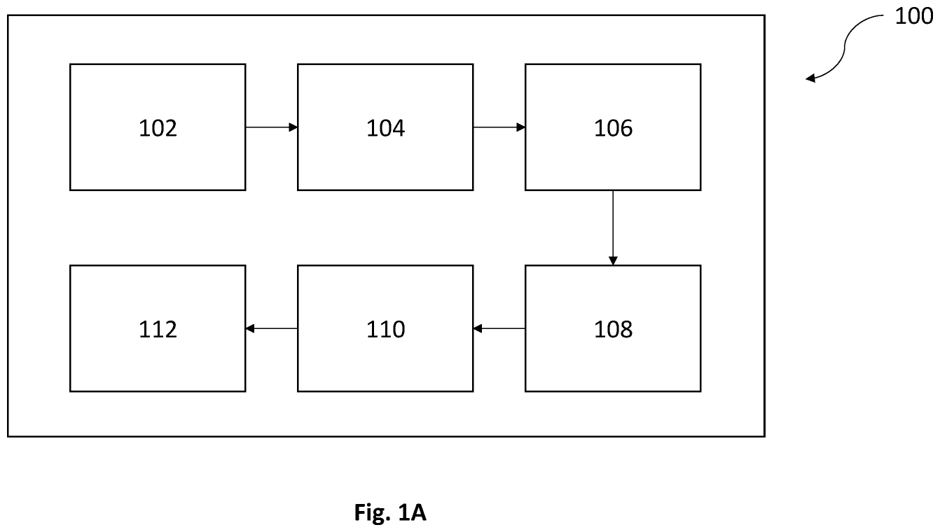

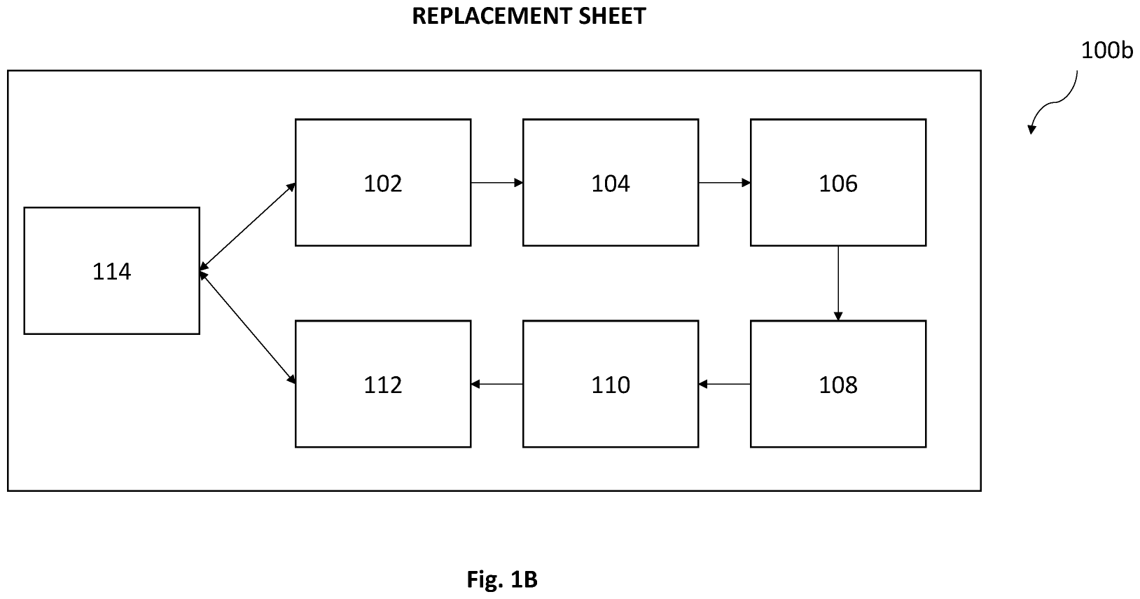

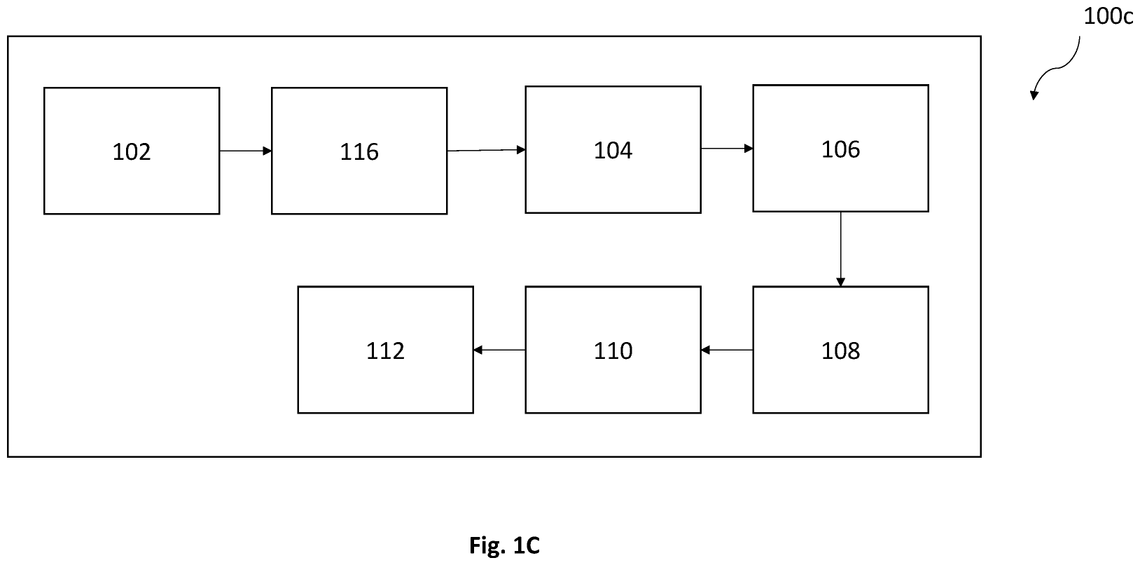

Referring to FIG. 1A, the present invention discloses an intelligent platform (100) for recommending financial advice using a custom data collection process to a user, in accordance with an embodiment of the present disclosure. The intelligent platform (100) comprises a data collection module (102) configured to collect real-time data associated with a plurality of financial streams. This data collection module (102) serves as the foundational component for gathering comprehensive financial data from various sources, ensuring that the platform has access to the most current and relevant information.

The intelligent platform (100) further includes a database arrangement (104) operatively coupled to the data collection module (102). The database arrangement (104) is designed to store and manage a wide array of audit standards and other professional standards for financial processes, each associated with the plurality of financial streams. This database ensures that all collected data is processed and evaluated according to established standards, thereby maintaining the integrity and compliance of the financial output generated by the platform.

A critical component of the intelligent platform (100) is the processing arrangement (106), which is communicably coupled to the database arrangement (104) via a data communication network. The processing arrangement (106) is configured to receive real-time data from the plurality of financial streams. It characterizes the various audit standards associated with these financial streams into a unified audit and compliance unit. Such unified unit integrates and connects each of the financial streams, ensuring a comprehensive and cohesive approach to financial auditing and compliance.

The intelligent platform (100) also comprises an Artificial Intelligence (AI) module (108) configured to analyze the real-time data from the plurality of financial streams using the unified audit and compliance unit. The AI module (108) creates a customised query-based process for gathering and validating specific customised information from the user. Said customised information is then used to determine insights tailored to the financial situation of a client for whom the user is analysing the financial situation. The AI module (108) processes the real-time data alongside user-specific information to provide detailed insights into various financial and audit processes.

In addition, the intelligent platform (100) includes a document generator (110). The document generator (110) is responsible for generating reports based on the analysis of real-time data. These reports are associated with at least one financial or audit process and provide users with detailed, actionable insights and recommendations.

Moreover, the intelligent platform (100) comprises a display arrangement (112) that is communicably coupled to the document generator (110). The display arrangement (112) is designed to present the generated reports and recommend advice to the user in an accessible and user-friendly format. This ensures that users can easily interpret the data and insights provided by the platform and make informed decisions based on comprehensive financial advice.

In describing further to FIG. 1A, reference is made to FIG. 1B where there is illustrated an intelligent platform (100), in accordance with an embodiment of the present disclosure. The intelligent platform (100) further comprises a user interface (114) configured to receive user input in the form of at least one query from at least one user. The user interface (114) serves as an interactive component that allows users to engage directly with the platform by inputting queries related to the data relevant to at least one of the plurality of financial streams.

In an instance, the user interface (114) enables users to pose specific questions or requests for information regarding financial data. Such queries can pertain to various aspects of the financial streams integrated within the platform, such as account balances, transaction histories, investment performance, or compliance status. The ability to input such queries empowers users to access precise and customized information from the system, facilitating a more customized and responsive financial advisory experience for an auditor or tax consultant or financial expert.

Upon receiving a query, the user interface (114) communicates with the underlying components of the platform, including the data collection module (102), database arrangement (104), and AI module (108). Said interaction ensures that the user's queries are processed in real-time, leveraging the comprehensive data and advanced analytical capabilities of the platform to generate accurate and relevant responses. Consequently, the intelligent platform (100) provides users with timely and insightful information tailored to the specific financial needs and questions of the client for whom the user is using the system.

In another embodiment, the user interface (114) displays data associated with the at least one of the plurality of financial stream, to the display arrangement (112), based on the at least one query.

In another embodiment, the plurality of financial streams refers to the data associated with multiple aspects of the plurality of financial processes. Said multiple aspects of the financial processes comprise at least one of bookkeeping, audit, tax, and financial management.

In another embodiment, the AI module (108) is trained using the data from the plurality of financial streams, thereby optimizing each of the plurality of financial processes. In an instance, the AI module (108) leverages extensive datasets derived from various financial streams, including bookkeeping, audit, tax, and financial management data. By training on this diverse and comprehensive data, the AI module (108) develops a deep understanding of the patterns, trends, and intricacies within each financial process. Such training enables the AI module (108) to enhance and optimize the performance of the financial processes in several ways. For bookkeeping, the AI module (108) can automate routine tasks such as transaction categorization and reconciliation, reducing manual effort and increasing accuracy. In another instance, the AI module (108) can identify anomalies and potential compliance issues more efficiently, improving the reliability and thoroughness of audit processes. In yet another instance, for tax-related processes, the AI module (108) can ensure that tax calculations and filings are accurate and compliant with the latest regulations, minimizing the risk of errors and penalties. In financial management, the AI module (108) can assist in strategic decision-making by providing predictive analytics, budgeting recommendations, and investment insights based on real-time data and historical trends.

In a particular embodiment, the AI module (108) is configured to automate the at least one of the financial processes.

According to another embodiment, the present invention discloses that the intelligent platform (100) is configured to operate in a cloud-based architecture, providing seamless access and real-time updates. In an instance, such cloud-based architecture enables the platform to deliver robust and scalable financial advisory services. By leveraging cloud infrastructure, the platform ensures that users can access financial data and insights from any location with an internet connection, using a variety of devices such as desktops, laptops, tablets, and smartphones. Said flexibility enhances user convenience and supports remote financial management and advisory activities for the user who is a financial advisor to an organisation or a user, financial expert, tax consultant.

Moreover, operating in a cloud-based environment allows the platform to provide real-time updates. As financial data is collected and processed, the cloud infrastructure ensures that any changes or new information are instantly reflected across the system. Such capability is crucial for maintaining the accuracy and relevance of financial advice.

In another embodiment, the intelligent platform (100) includes a display arrangement (112) that displays data associated with the analyzed insightful insights. The displayed data corresponds to insightful data in the form of generated reports and relevant data analytics.

In a further embodiment, the intelligent platform (100) further comprises an API integration module configured to provide seamless integration with existing systems. Such API integration module serves as a bridge between the intelligent platform (100) and external systems, allowing for smooth communication and data exchange. By leveraging Application Programming Interfaces (APIs), the platform can connect with various third-party software, databases, and services commonly used in the financial industry. Such API integration module facilitates interoperability and interoperable data sharing, enabling the intelligent platform (100) to access additional sources of financial data and functionality. For example, it can integrate with banking systems, investment platforms, accounting software, tax preparation tools, and regulatory compliance databases.

In describing further on FIG. 1A, reference is made to FIG. 1C where there is illustrated a schematic illustration of intelligent platform in accordance with another embodiment. Herein, an Optical character recognition, OCR module (116) is disclosed for automating extraction of data, minimizing reliance on manual input, and ensuring an error-free process.

According to an embodiment, each of the plurality of audit standards comprises: roles and responsibilities; risk assessment and response to assessed risks; audit evidence; using data from external sources; and audit conclusion and reporting.

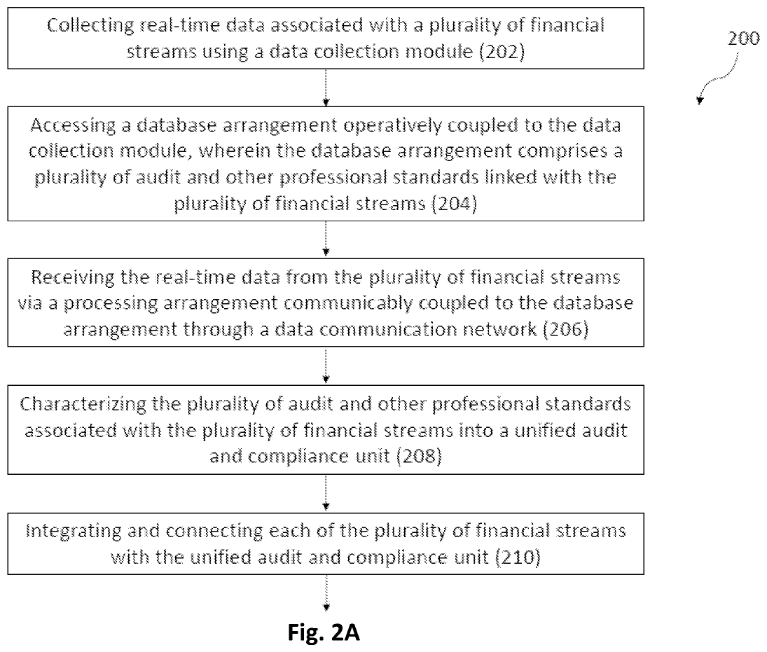

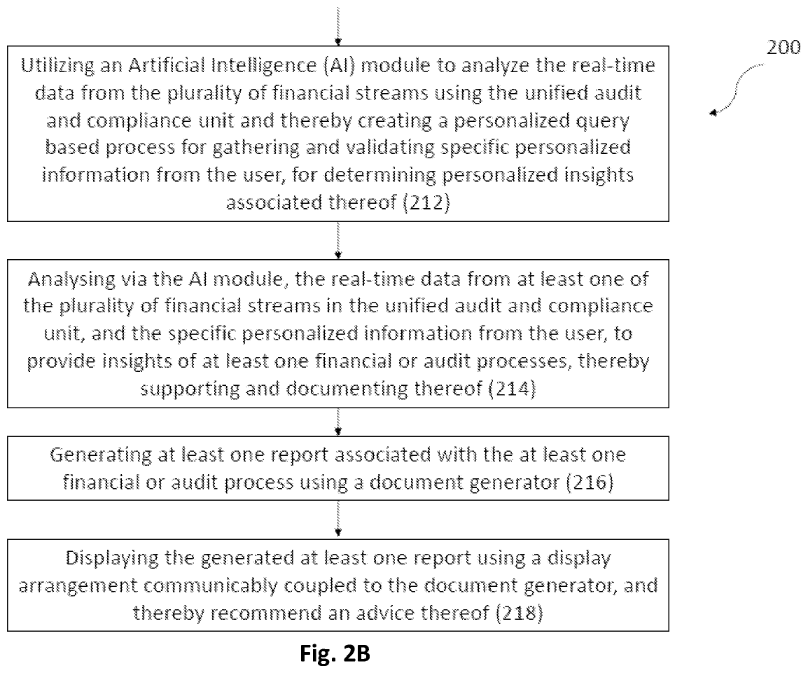

Reference is made to FIG. 2A and FIG. 2B, where there is illustrated a method for recommending financial advice to a user, in accordance with an embodiment of the present disclosure. The method (200) initiates at step (202) which includes collecting real-time data associated with a plurality of financial streams using a data collection module. The method further proceeds to step (204), which includes accessing a database arrangement operatively coupled to the data collection module, wherein the database arrangement comprises a plurality of audit and other professional standards linked with the plurality of financial streams. Further, at step (206), the method comprises receiving the real-time data from the plurality of financial streams via a processing arrangement communicably coupled to the database arrangement through a data communication network. Furthermore, at step (208), the method comprises characterizing the plurality of audit and other professional standards associated with the plurality of financial streams into a unified audit and compliance unit. Subsequently at step (210), the method comprises integrating and connecting each of the plurality of financial streams with the unified audit and compliance unit, and at step (212), the method comprises utilizing an Artificial Intelligence (AI) module to analyze the real-time data from the plurality of financial streams using the unified audit and compliance unit and thereby creating a personalized query based process for gathering and validating specific customised information from the user, for determining customised insights associated thereof. Thereafter, the method comprises analysing via the AI module, the real-time data from at least one of the plurality of financial streams in the unified audit and compliance unit, and the specific customised information from the user, to provide insights of at least one financial or audit processes, thereby supporting and documenting thereof, at step (214). The method further comprises generating at least one report associated with the at least one financial or audit process using a document generator, at step (216). In addition, the method (200) also comprises displaying the generated at least one report using a display arrangement communicably coupled to the document generator, and thereby recommend an advice thereof. The final step (218) comprises displaying the generated at least one report using a display arrangement communicably coupled to the document generator, and thereby recommend an advice thereof.

The steps 202, 204, 206, 208, 210, 212, 214, 216, and 218 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural where appropriate.

1. An intelligent platform (100) for recommending financial advice using a custom data collection process, to a user, wherein the intelligent platform (100) comprising:
a data collection module (102) configured to collect real-time data associated with a plurality of financial streams;
a database arrangement (104) operatively coupled to the data collection module (102), the database arrangement (104) comprises a plurality of audit standards or other professional standards for financial processes, associated with the plurality of financial streams;
a processing arrangement (106) communicably coupled to the database arrangement (104) via a data communication network, the processing arrangement (106) is configured to:
receive the real-time data from the plurality of financial streams;
characterize the plurality of audit standards associated with the plurality of financial stream, into a unified audit and compliance unit; and
integrate and connect the each of the plurality of financial streams with the unified audit and compliance unit;
an artificial intelligence, AI module (108) for analysing the real-time data from the plurality of financial streams using the unified audit and compliance unit and thereby creating a customised query based process for gathering and validating specific customised information from the user, for determining customised insights associated thereof,
wherein the AI module (108) analyses the real-time data from at least one of the plurality of financial streams in the unified audit and compliance unit, and the specific personalized information from the user, to provide insights of at least one of a financial or audit processes;
a document generator (110) for generating at least one report associated with the at least one financial or audit process based on the analysis of the real-time data; and
a display arrangement (112) communicably coupled to the document generator (110), for displaying the generated at least one report, and recommending advice to the user.

2. The intelligent platform (100) of claim 1, further comprises a user interface (114) for receiving a user input in form of at least one query thereof via at least one user, and wherein the at least one query is associated with querying the data relevant to at least one of the plurality of financial stream.

3. The intelligent platform (100) of claim 2, wherein the user interface (114) displays data associated with the at least one of the plurality of financial stream, to the display arrangement (112), based on the at least one query.

4. The intelligent platform (100) of claim 1, wherein the plurality of financial streams refer to the data associated with multiple aspects of the plurality of financial processes, and wherein the multiple aspects of the plurality of financial processes comprises at least one of bookkeeping, audit, tax, financial management.

5. The intelligent platform (100) of claim 1, wherein the AI module (108) is trained using the data from the plurality of financial streams, and thereby optimizes each of the plurality of financial processes.

6. The intelligent platform (100) of claim 1, is configured to operate in a cloud-based architecture for providing seamless access and real-time updates.

7. The intelligent platform (100) of claim 1, wherein the AI module (108) is configured to automate the at least one of the financial processes.

8. The intelligent platform (100) of claim 1, wherein the display arrangement (112) displays data associated with the analysed insightful insights, and wherein the displayed data corresponds to insightful data in form of the generated report, and relevant data analytics.

9. The intelligent platform (100) of claim 1, further comprises an API integration module for providing integration thereof with existing systems.

10. The intelligent platform (100) of claim 1, further comprises an Optical character recognition, OCR module (116) for automating extraction of data, minimizing reliance on manual input, and ensuring an error-free process.

11. The intelligent platform (100) of claim 1, wherein each of the plurality of audit standards comprises:
roles and responsibilities;
risk assessment and response to assessed risks;
audit evidence;
using data from external sources; and
audit conclusion and reporting.

12. A method (200) for recommending financial advice to a user using a custom data collection process, the method comprises:
collecting real-time data associated with a plurality of financial streams using a data collection module (202);
accessing a database arrangement operatively coupled to the data collection module, wherein the database arrangement comprises a plurality of audit and other professional standards linked with the plurality of financial streams (204);
receiving the real-time data from the plurality of financial streams via a processing arrangement communicably coupled to the database arrangement through a data communication network (206);
characterizing the plurality of audit and other professional standards associated with the plurality of financial streams into a unified audit and compliance unit (208);
integrating and connecting each of the plurality of financial streams with the unified audit and compliance unit (210);
utilizing an Artificial Intelligence (AI) module to analyze the real-time data from the plurality of financial streams using the unified audit and compliance unit and thereby creating a personalized query based process for gathering and validating specific personalized information from the user, for determining personalized insights associated thereof (212);
analysing via the AI module, the real-time data from at least one of the plurality of financial streams in the unified audit and compliance unit, and the specific personalized information from the user, to provide insights of at least one financial or audit processes, thereby supporting and documenting thereof (214);
generating at least one report associated with the at least one financial or audit process using a document generator (216); and
displaying the generated at least one report using a display arrangement communicably coupled to the document generator, and thereby recommend an advice thereof (218).
